(19) United States
(12) Patent Application Publication
(10) Pub. No.: US 2006/0145979 A1
(43) Pub. Date: Jul. 6, 2006

(54) Liquid crystal display and driving method thereof

(76) Inventors: Seung-Woo Lee, Seoul (KR); Yun-Ju Yu, Seoul (KR); Doo-Sik Park, Suwon-city (KR); Heui-Keun Choh, Seoul (KR); Chang-Yeong Kim, Yongin-city (KR); Yong-Koo Park, Suwon-city (KR)

Correspondence Address: Hae Chan Park;McGuireWoods, Suite 1800, 1750 Tysons Boulevard, McLean, VA, 22102, US

(21) Appl. No.: 10/534,623

(22) PCT Filed: Nov. 12, 2003
(86) PCT No.: PCT/KR03/02435

§ 371 Date: Dec. 27, 2005

(30) Foreign Application Priority Data
Nov. 12, 2002 (KR) 10-2002-0070051

(51) Int. Cl. G09G 3/36

(52) U.S. Cl. 345/88

(57) ABSTRACT

A liquid crystal display includes: a signal controller including a gamma converter outputting output image data have gamma characteristic adapted to a gamma 2.2 curve based on input image data with a bit number smaller than the output image data, a color correction unit including color coefficients for performing color correction on the image data from the gamma converter, and a dithering and FRC processor reducing a bit number of the image data from the color correction unit by taking upper bits of the image data and controlling position and frequency of the upper bits of the image data; a voltage generator generating a plurality of gray voltages by dividing a predetermined voltage lower than a supply voltage such that a predetermined one of the gray voltages gives a luminance of about 80 cd/m2; a data driver selecting the gray voltages from the voltage generator and outputting gray voltages corresponding to the image data from the signal controller; and an inverter controlling a lamp to emit a luminance higher than 80 cd/m2.

### BACKGROUND OF THE INVENTION

(a) Field of the Invention

The present invention relates to a liquid crystal display and a driving method thereof.

(b) Description of the Related Art

Recently, in the field of a display device such as a personal computer and a television it is required that the display device should involve a light weight, a thin thickness and a large screen size. In order to fulfill such requirements, a flat panel display such as a liquid crystal display (LCD) has been developed instead of the cathode ray tube, and applied for practical use in the field of desktop computers, and televisions.

The LCD has a panel with a matrix-typed pixel pattern, and a counter panel facing the former panel. A liquid crystal material bearing a dielectric anisotropy is injected between the two panels. The light transmission through the panels is controlled through varying the strength of the electric fields applied to both ends of the two panels, thereby displaying the desired images.

The display device usually represents original images on the screen by way of the RGB color space intrinsic thereto. That is, when the color space is expressed by way of a plurality of gray levels, gamma correction is made by way of a luminance curve corresponding to each gray level, that is, by way of a gamma curve. A color correction is additionally made, thereby recovering the original images. However, as the RGB color space is mostly device-dependent, the designer of the display device as well as the user thereof should consider the image profile intrinsic to the device when the original images are represented. This is a considerable burden to them. As the kind and the characteristic of the display device are diversified in various manners, it is needed to make a definition of a standard color space for the display device. In this connection, a sRGB color space being the unit standard RGB color space as the average concept of the RGB monitors was proposed on November, 1996 by the HP Company and the MS Company. Since then, the sRGB color space has been accepted as a standard color space on Internet.

A need is made to realize such a sRGB color space with the LCD.

Three requirements should be fulfilled to realize the sRGB color space with the LCD. First, the display luminance level with respect to the a predetermined input gray level should be established to be 80 cd/m². Second, the gamma curve expressing the luminance characteristic of the input gray level should agree to the gamma 2.2 curve. Third, the display model offset with respect to the RGB colors should be established to be zero.

It is required for the LCD to realize such a sRGB color space.

### SUMMARY OF THE INVENTION

It is a motivation of the present invention to provide a liquid crystal display which realizes a sRGB color space, and a driving method thereof.

A liquid crystal display includes: a signal controller including a gamma converter outputting output image data have gamma characteristic adapted to a gamma 2.2 curve based on input image data with a bit number smaller than the output image data, a color correction unit including color coefficients for performing color correction on the image data from the gamma converter, and a dithering and FRC processor reducing a bit number of the image data from the color correction unit by taking upper bits of the image data and controlling position and frequency of the upper bits of the image data; a voltage generator generating a plurality of gray voltages by dividing a predetermined voltage lower than a supply voltage such that a predetermined one of the gray voltages gives a luminance of about 80 cd/m²; a data driver selecting the gray voltages from the voltage generator and outputting gray voltages corresponding to the image data from the signal controller; and an inverter controlling a lamp to emit a luminance higher than 80 cd/m².

The liquid crystal display further includes an inverter controlling a lamp such that the lamp emits light with a luminance of 80 cd/m² or more.

### BRIEF DESCRIPTION OF THE DRAWINGS

The present invention will become more apparent by describing embodiments thereof in detail with reference to the accompanying drawings in which:

FIG. 1 is a block diagram of an LCD according to an embodiment of the present invention;

FIG. 2A shows an exemplary graph illustrating gamma curves of an LCD including an original gamma curve and a gamma 2.2 curve for sRGB color space;

FIG. 2B FIG. 2B, which is a graph illustrating luminance of an LCD as function of gray voltage;

FIG. 3 is a detailed block diagram of the luminance controller and the gamma converter shown in FIG. 1;

FIG. 4 is a graph showing a gamma 2.2 curve and an original gamma curve for illustrating the conversion of the gamma curve at the gamma converter shown in FIG. 3;

FIG. 5 illustrates exemplary two-bit dithering and FRC performed by the dithering and FRC processor 44;

FIG. 6 is a flow chart illustrating an exemplary color correction according to an embodiment of the present invention;

FIGS. 7 and 8 are block diagrams of an LCD according to other embodiments of the present invention;

FIG. 9 is a graph illustrating the gray difference between input image data and corresponding output (target) image data as function of the gray of the input image data in an LCD according to an embodiment of the present invention;

FIG. 10 is a flowchart illustrating an exemplary gamma conversion process by way of mathematical operation in an LCD according to an embodiment of the present invention; and

FIG. 11 illustrates a method of driving an LCD in a sRGB color space according to an embodiment of the present invention.

### DETAILED DESCRIPTION OF EMBODIMENTS

The present invention now will be described more fully hereinafter with reference to the accompanying drawings, in which preferred embodiments of the inventions are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Now, liquid crystal displays and driving methods thereof according to embodiments of the present invention will be described with reference to the accompanying drawings.

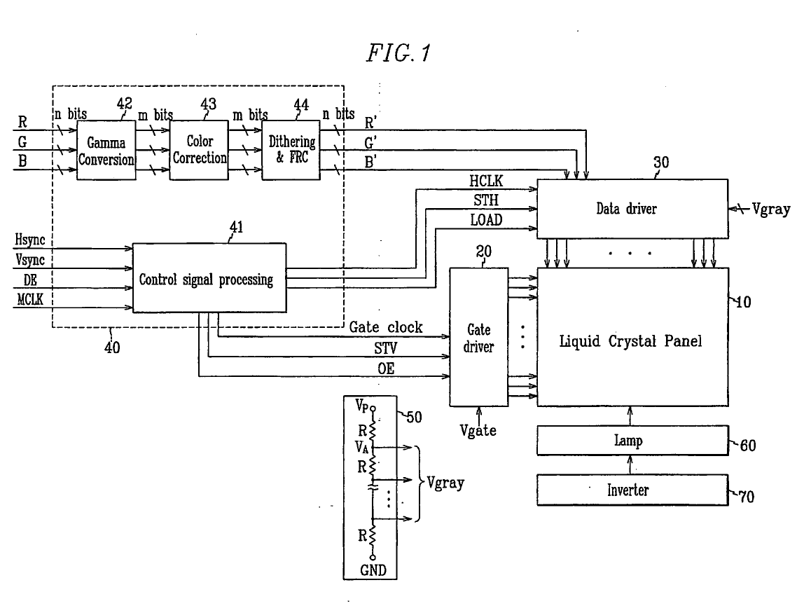

FIG. 1 is a block diagram of an LCD according to an embodiment of the present invention.

As shown in FIG. 1, an LCD according to an embodiment of the present invention includes a liquid crystal panel assembly 10, a gate driver 20, a data driver 30, a signal controller 40, a voltage generator 50, a lamp 60, and an inverter 70.

The liquid crystal panel assembly 10 includes a plurality of gate lines (not shown) extending in a transverse direction and transmitting gate voltages, a plurality of data lines (not shown) extending in a longitudinal direction and transmitting data voltages, and a plurality of pixels (not shown) connected to the gate lines and the data lines and arranged in a matrix. Each pixel includes a liquid crystal capacitor (not shown) and a switching element such as a thin film transistor (TFT) selectively transmitting the data voltages to the liquid crystal capacitor in response to the gate voltages.

The signal controller 40 receives image data RGB from an external graphic source (not shown) together with input control signals such as synchronization signals Hsync and Vsync, a data enable signal DE, and a clock signal MCLK for displaying the image data RGB. The signal controller 40 performs gamma correction and color correction on the image data RGB, and outputs the corrected image data R′G′B′ to the data driver 30. Furthermore, the signal controller 40 generates control signals such as a horizontal clock signal HCLK, a horizontal synchronization start signal STH, a load signal LOAD, a gate clock signal Gate dock, a vertical synchronization start signal STV, and an output enable signal OE for controlling the display operations of the gate driver 20 and the data driver 30, and outputs them to the relevant drivers 20 and 30.

The signal controller 40 includes a control signal processing block 41 and a data processing block including a gamma converter 42, a color corrector 43, and a dithering and frame rate control (FRC) processor 44.

The control signal processing block 41 generates the control signals HCLK, STH, LOAD, Gate clock, STV and OE based on the synchronization signals Hsync and Vsync, the data enable signal DE, and the clock signal MCLK.

The gamma converter 42 converts a gamma characteristic of the image data such that it is adapted to a gamma 2.2 curve as well as it increases the bit number of the image data, and it outputs the converted image data. The gamma converter 42 may perform the gamma conversion by way of a look-up table (LUT) or a mathematical operation realized on an application specific integrated circuit (ASIC). The configuration shown in FIG. 1 is obtained when using a look-up table. In this case, the look-up table includes a mapping from the original (input) image data RGB to the converted (output) image data. The gamma converter 42 retrieves a converted data corresponding to an input image data from the look-up table, and it output the converted image data. FIG. 1 shows that the bit number (m bits) of the converted image data is larger than the bit number (n bits) of the original image data RGB in order to enhance the precision of the gamma conversion.

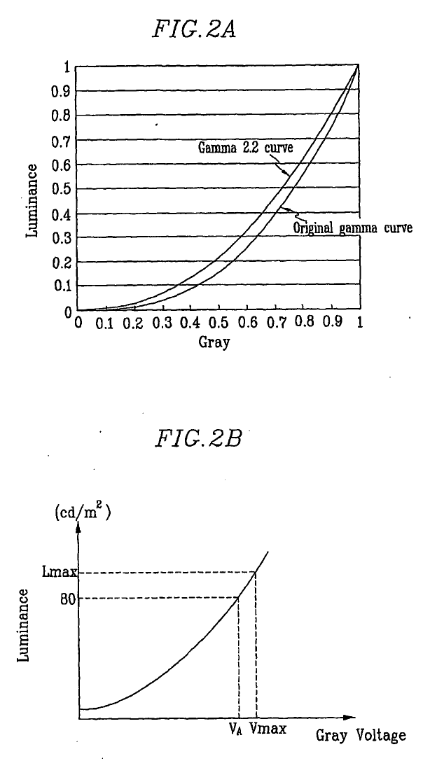

FIG. 2A shows an exemplary graph illustrating gamma curves of an LCD including an original gamma curve and a gamma 2.2 curve for a standard RGB (sRGB) color space. In the figure, a horizontal axis indicates a normalized input gray level while a vertical axis indicates a normalized luminance.

The color corrector 43 performs color correction on the converted m bit image data from the color converter 42. The color correction minimizes the difference between the color represented by the LCD and the color on the sRGB color space within the limitations of the LCD.

The dithering and FRC processor 44 converts the m bit image data from the color corrector 43 into n bit output image data R′G′B′ by performing spatial dithering and temporal FRC and it outputs the processed output image data R′G′B′ to the data driver 30.

The voltage generator 50 includes a plurality of resistors R connected in series (or in parallel) between a predetermined voltage Vp and a ground voltage GND for generating a plurality of gray voltages. The resistors divide the supply voltage Vp to be provided as the gray voltages Vgray for the data driver 30. A predetermined voltage V_{A} giving 80 cd/m² is selected as shown in FIG. 2B, which is a graph illustrating luminance of an LCD as function of gray voltage. Since the gray voltages made by dividing a typical supply voltage give a maximum luminance of about 250 cd/m², the selected voltage V_{A} is smaller than the typical supply voltage. Accordingly, the voltage generator 50 can generate the gray voltages based on the voltage Vp lower than the supply voltage, thereby reducing power consumption.

The data driver 30 receives and stores the converted image data R′G′B′ from the gamma converter 42 of the signal controller 40 in synchronization with the control signals HCLK and STH. The data driver 30 receives the gray voltages Vgray, which are analog voltages to be actually applied to the liquid crystal panel assembly 10, from the voltage generator 50. The data driver 30 selects the gray voltages Vgray corresponding to the image data R′G′B′ for the respective pixels, and outputs the selected gray voltages as the data voltages to the liquid crystal panel assembly 10 in response to the load signal LOAD.

The gate driver 20 receives the gate clock signal Gate clock, the output enable signal OE, and the vertical synchronization start signal STV from the signal controller 40, and it also receives gate voltages Vgate from a gate voltage generator (not shown). The gate driver 20 sequentially outputs the gate voltages for selecting the gate lines on the liquid crystal panel assembly 10 in accordance with the output enable signal OE and the gate clock signal Gate clock, thereby sequentially scanning the gate lines on the liquid crystal panel assembly 10.

The lamp 60 and the inverter 70 form a backlight for the liquid crystal panel assembly 10, and the inverter 70 controls the light emission of the lamp 60. In this embodiment, it is established that the inverter 70 controls the lamp 60 with a luminance of 80 cd/m² or more to fulfill the luminance requirement of the sRGB color space.

When a gate line is selected by the gate voltages Vgate, the pixels connected to the gate line become in a write-enable state to be applied with the data voltages through the data lines. The pixels display predetermined luminance levels corresponding to the data voltages and a desired image is displayed on an entire screen in such a way.

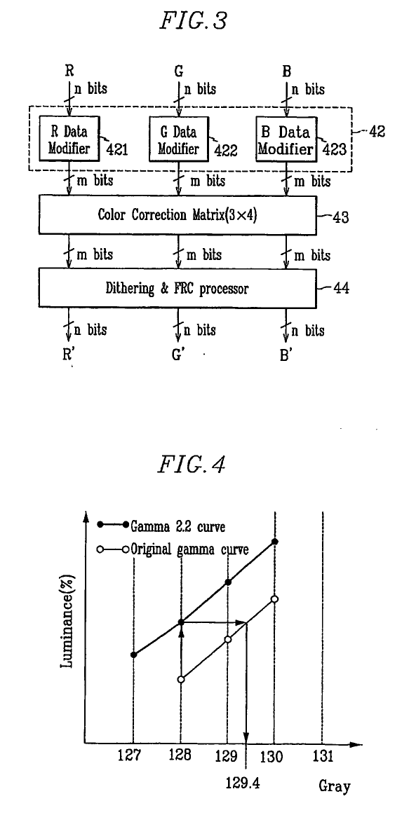

The operation of the gamma converter 42, the color corrector 43, and the dithering and FRC processor 44 will be now described more in detail with reference to FIGS. 3 and 4.

FIG. 3 is a detailed block diagram of the gamma converter 42, the color corrector 43, and the dithering and FRC processor 44 shown in FIG. 1, and FIG. 4 is a graph showing a gamma 2.2 curve and an original gamma curve for illustrating the conversion of the gamma curve at the gamma converter 42 shown in FIG. 3.

As shown in FIG. 3, the gamma converter 42 includes an R data modifier 421, a G data modifier 422, and a B data modifier 423. The data modifiers 421-423 perform the conversion of the gamma characteristics in relation to the respective RGB colors.

More specifically, each data modifier 421-423 maps an input image data representing a luminance level on the gamma 2.2 curve into an output image data representing the same luminance level on the original gamma curve. As shown in FIG. 4, it is assumed that the gray level of the input image data is 128. The luminance of the 128-th gray level on the original gamma curve is different from the luminance of the 128-th gray level on the gamma 2.2 curve. Instead, the 129.4-th gray level on the original gamma curve represents the same luminance as the 128-th gray level on the gamma 2.2 curve. Each data modifier 421-423 maps the input image data with the 128-th gray level into the output image data with the 129.4-th gray level. For this purpose, each data modifier 421-423 includes a look-up table including a map between gray levels on the gamma 2.2 curve and gray levels on the original gamma curve, which represent equal luminance. The look-up tables for the data modifiers 421-423 may be implemented in respective non-volatile memories such as ROM (read only memory) or implemented in one ROM. The bit number of the output image data is larger than that of the input image data such that decimals under the decimal point of the gray levels as shown in FIG. 4 can be expressed.

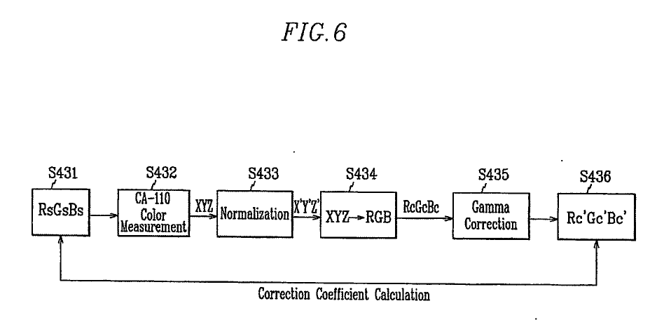

The color corrector 43 performs color correction by applying an equation including (a) color correction coefficient(s) to the image from the gamma converter 42. An exemplary matrix in this embodiment is a 3×4 matrix and the color correction is described in detail with reference to FIG. 6.

FIG. 6 is a flow chart illustrating an exemplary color correction according to an embodiment of the present invention.

Upon receipt of image data RsGsBs on a sRGB color space (S431), the colors display by the LCD based on the input image data RsGsBs are measured using a measuring device and color values xyY for respective color patches are obtained. The obtained color values xyY are converted into tristimulus values XYZ (S432). A three-dimensional space X_{N}Y_{N}X_{N} is defined and the tristimulus values XYZ are normalized using Y_{N} (S433). A standard “white” is defined to be 80 cd/m² according the standards of the sRGB color space. The normalized tristimulus values XYZ are then converted into linear image data R_{C}G_{C}B_{C} (S434), which are subject to gamma correction (S435) to be converted into nonlinear image data R_{C}′G_{C}′B_{C}′ (S436). Finally, a color matching matrix between the image data RsGsBs on the sRGB color space and the nonlinear image data R_{C}′G_{C}′B_{C}′ is obtained and the elements of the matching matrix are used as coefficients of the color correction matrix. An exemplary color correction matrix is given by:

$$( \begin{matrix}{R}_{s} \\ {G}_{s} \\ {B}_{s}\end{matrix} ) = ( \begin{matrix}0.9535 & 0.0412 & 0.0620 & 2.4168 \\ - 0.0717 & 1.1813 & - 0.0851 & - 14.9909 \\ 0.0456 & - 0.1423 & 1.1649 & - 16.0530\end{matrix} ) ( \begin{matrix}{R}_{C} \\ {B}_{C} \\ {G}_{C} \\ 1\end{matrix} ) \qquad ( 1 )$$

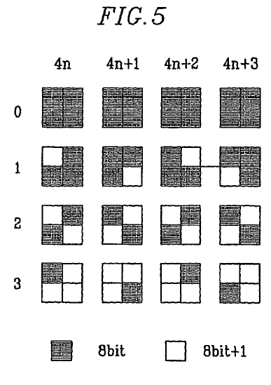

The dithering and FRC processor 44 reduces the bit number of the image data from the color corrector 43, which will be described in detail with reference to FIG. 5.

FIG. 5 illustrates exemplary two-bit dithering and FRC performed by the dithering and FRC processor 44. For example, the dithering and FRC shown in FIG. 5 is applied when 10 bit data is reduced into 8 bit data.

As described above in relation FIG. 4, an 8 bit image data with the 128-th gray may be converted into a 10 bit image data with the 129.4-th gray by the gamma converter 42 in an LCD having 256 grays. The number under the decimal point is approximated as lower two bits of a 10 bit number. For example, 0.4 is approximated as (0000000010) in the binary number system.

The recovery from a 10 bit data to an 8 bit data is such that lower two bits are represented by spatial average over a predetermined number of pixels and temporal average over a predetermined number of frames. Referring to FIG. 5, lower two bits are 0=(00), 1=(01), 2=(10), and 3=(11). Regarding the dithering, the lower two bits are expressed as the average data of four adjacent pixels forming a 2×2 matrix. For example, if the lower two bits are (01), three of the four pixels represent upper 8 bits and one of the four pixels represents upper 8 bits plus one. Regarding the FRC, the lower two bits are expressed as the average data of four successive frames. For example, if the lower two bits are (10), each pixel represents upper 8 bits during two of the four frames and represents upper 8 bits plus one during the remaining two of the four frames. In order to prevent all pixels from flickering simultaneously, it is controlled such that all of the four pixels forming a 2×2 matrix may not represent the same data during one frame as shown in FIG. 5.

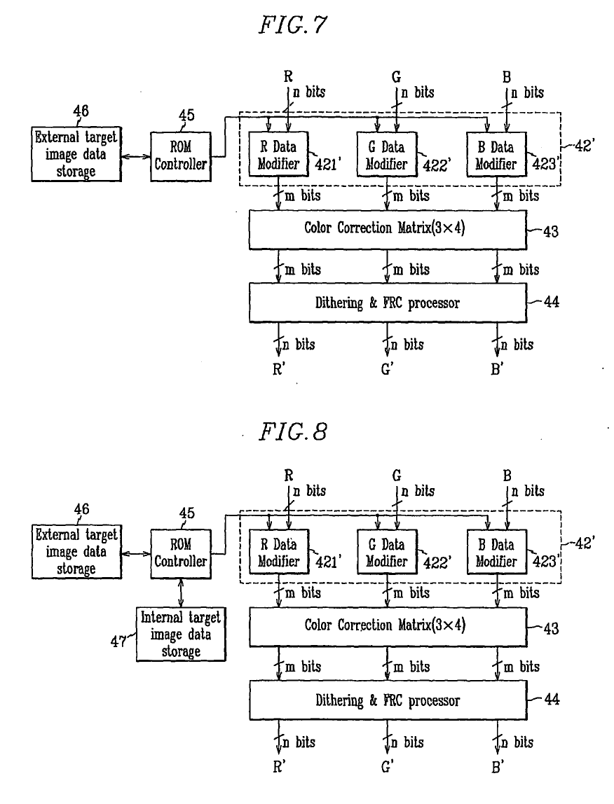

FIGS. 7 and 8 are block diagrams of an LCD according to other embodiments of the present invention.

The LCD shown in FIG. 7 further includes a ROM controller 44 and an external target image data storage 45 in addition to a gamma converter 42′. The gamma converter 42′ includes R, G and B data modifiers 421′-423′, each including a volatile memory such as a random access memory (RAM).

The external target image data storage 45 stores a look-up table including a map between gray levels on the gamma 2.2 curve and gray levels on the original gamma curve for each color, which represent equal luminance. The ROM controller 44 loads the look-up table in the storage 45 into the R, G and B data modifiers 421′-423′. Since the other operations are similar to those shown in FIG. 3, the description thereof is omitted here.

Since the look-up table is stored in the external storage 45, this embodiment easily copes with the alteration of the panel assembly 10 without changing the gamma converter 42′.

The LCD shown in FIG. 8 further includes an internal target image data storage 46 as well as a ROM controller 44, an external target image data storage 45 in addition to a gamma converter 42′ as compared with the LCD shown in FIG. 7. The gamma converter 42′ also includes R, G and B data modifiers 421′-423′, each including a volatile memory such as a random access memory (RAM).

Like the external target image data storage 45, the internal target image data storage 46 stores a look-up table including the above-described map. The ROM controller 44 loads the look-up table stored in the external storage 45 or in the internal storage 46 into the R, G and B data modifiers 421′-423′. Other operations are similar to those shown in FIG. 3, and hence, description thereof will be omitted here.

Now, gamma conversion by way of a mathematical operation according to an embodiment of the present invention will be described with reference to FIGS. 7 and 8.

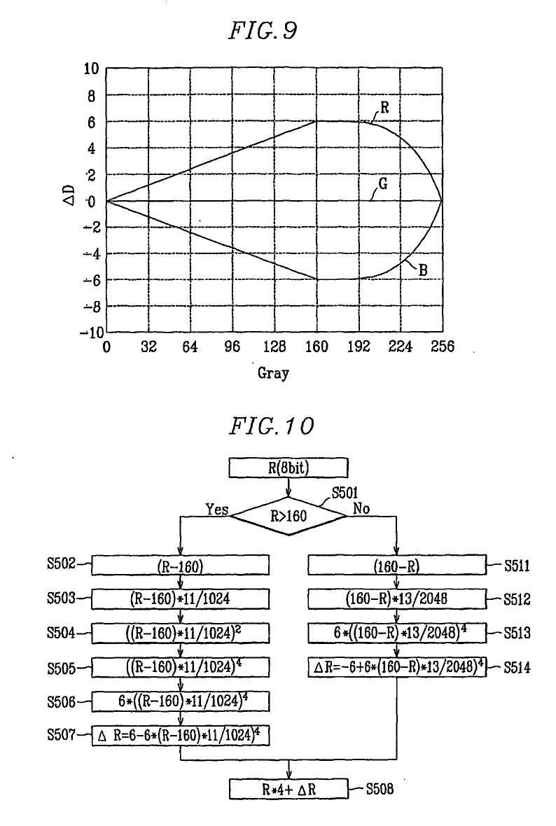

FIG. 9 is a graph illustrating the gray difference between input image data and corresponding output (target) image data as function of the gray of the input image data in an LCD according to an embodiment of the present invention, and FIG. 10 is a flowchart illustrating in exemplary gamma conversion process by way of mathematical operation in an LCD according to an embodiment of the present invention.

It is assumed that the image data RGB are 8 bit signals capable of representing 256 grays.

As shown in FIG. 9, there is no gray difference between the target image data and the original image data for green image data G, while curves illustrating the gray difference between the target image data and the original image data for red and blue image data R and B change their shape near the gray level of 160. The gray difference ΔR and ΔB between the original data and the target data for red and blue image data R and B can be approximately expressed by:

$$\begin{matrix}Δ R = 6 - \frac{6 \times ( 160 - R )}{160} if R < 160 , and \\ 6 - \frac{6 \times {( R - 160 )}^{4}}{{( 255 - 160 )}^{4}} if R \geq 160 ; and & ( 2 ) \\ Δ B = - 6 + \frac{6 \times ( 160 - B )}{160} if B < 160 , and \\ 6 - \frac{6 \times {( B - 160 )}^{4}}{{( 255 - 160 )}^{4}} if B \geq 160 , & ( 3 )\end{matrix}$$

where R and B are the grays of the original data for red and green image data, respectively.

First, as shown in FIG. 10, when an 8 bit red image data are input, it is determined whether the gray R of the input data is larger than a critical value of “160” (S501).

When the input gray R is larger than the critical value, the critical value is subtracted from the input gray (S502). Then, the resultant value (R−160) nay be multiplied by 1/(255−160). However, since 1/(255−160) is roughly approximated to 11/1024(=210), for the purpose of simplification, (R−160) is multiplied by 11 and the lower 10 bits are rounded off (S503). Thereafter, (R−160)×11/1024 may be squared twice in a sequential manner. These operations can be made by way of a pipeline on ASIC (S504, S505). The resultant value of ((R−160)×11/1024)⁴ is multiplied by 6 (S506) and the resultant value of 6×(((R−160)×11/1024)⁴) is subtracted from 6, thereby obtaining the value of ΔR in accordance with Relation 2 (S507).

When the input gray R is smaller than the critical value in the step 501, the input gray R are subtracted from the critical value (S511). Then, the resultant value (160−R) may be multiplied by 1/160. However, since 1/160 is roughly approximated to 13/2048(=2¹¹), (160−R) is multiplied by 13 and then the lower 11 bits are rounded off (S512). Thereafter, (160−R)×13/2048 is multiplied by 6 (S513). The resultant value of ((160−R)×13/2048)×6 from the step S513 is subtracted from 6, thereby obtaining the value of ΔR in accordance with Relation 2 (S514).

In order to get 10 bit output data from ΔR obtained at the step S507 or S514, the 8 bit input data is multiplied by “4” to be converted into 10 bit data and is added to the calculated value ΔR (S508).

Similarly, blue output image data B′ can be calculated based on Relation 3.

The gamma conversion by way of a mathematical operation does not require a memory for storing a look-up table. The storage capacity of ROM or RAM required for storing the look-up table is considerably great. For instance, the storage capacity of 7680 (=3×256×10) bits are required for conversion between 8 bit image data and 10 bit image data. Accordingly, the gamma conversion according to this embodiment removes a large amount of storage capacity and reduces the power consumption due to the memory.

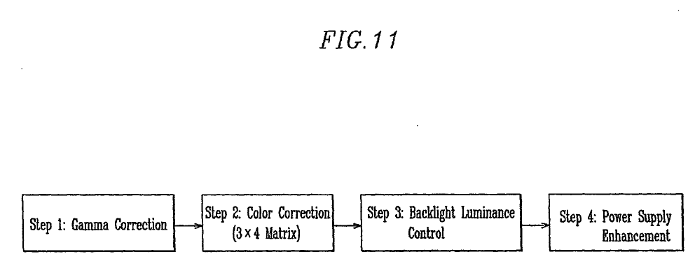

FIG. 11 illustrates a method of driving an LCD in a sRGB color space according to an embodiment of the present invention.

As shown in FIG. 11, a method of driving an LCD including a backlight unit according to an embodiment of the present invention includes a first step for gamma correction, a second step for color correction, a third step for controlling the backlight, and a fourth step for gray voltage generation. The backlight unit includes at least one lamp and an inverter for controlling the lamp.

The first step converts the gamma characteristic of the input image data to be adapted to the gamma 2.2 curve.

In the second step, a 3×4 color correction matrix is used for color correction such that the colors display by the LCD is approximated to the colors on the sRGB color space.

In the third step, the inverter is controlled such that the lamp emits light with a luminance equal to or larger than 80 cd/m², which is required for the sRGB color space.

The fourth step is performed in order that gray voltages satisfy a luminance requirement for the sRGB color space. In detail, the gray voltages are generated such that a predetermined gray voltage V_{A} gives 80 cd/m².

As described above, a series of gamma conversion, color correction, and luminance control provides the realization of the sRGB mode in the LCD and improves the display quality of the LCD.

While the present invention has been described in detail with reference to the embodiments, those skilled in the art will appreciate that various modifications and substitutions can be made thereto without departing from the spirit and scope of the present invention as set forth in the appended claims.

What is claimed is:

1. A liquid crystal display comprising:
a signal controller including a gamma converter outputting output image data have gamma characteristic adapted to a gamma 2.2 curve based on input image data with a bit number smaller than the output image data, a color correction unit including color coefficients for performing color correction on the image data from the gamma converter, and a dithering and FRC processor reducing a bit number of the image data from the color correction unit by taking upper bits of the image data and controlling position and frequency of the upper bits of the image data;
a voltage generator generating a plurality of gray voltages by dividing a predetermined voltage lower than a supply voltage such that a predetermined one of the gray voltages gives a luminance of about 80 cd/m²;
a data driver selecting the gray voltages from the voltage generator and outputting gray voltages corresponding to the image data from the signal controller; and
an inverter controlling a lamp to emit a luminance higher than 80 cd/m².

2. The liquid crystal display of claim 1, wherein the gamma converter comprises an R data modifier, a G data modifier and a B data modifier for performing the gamma conversion for the input image data for respective red, green and blue colors, and each of the data modifiers maps the input image data into output image data having a gamma characteristic adapted to the gamma 2.2 curve.

3. The liquid crystal display of claim 2, wherein the data modifiers include a nonvolatile memory.

4. The liquid crystal display of claim 1, wherein the color correction coefficients are expressed in a 3×4 color correction matrix.

5. The liquid crystal display of claim 4, wherein the color correction unit performs a matrix operation given by:
$$( \begin{matrix}{R}_{s} \\ {G}_{s} \\ {B}_{s}\end{matrix} ) = M ( \begin{matrix}{R}_{C} \\ {B}_{C} \\ {G}_{C} \\ 1\end{matrix} ) ,$$
where M is the color correction matrix.

6. The liquid crystal display of claim 5, wherein the color correction matrix is given by:
$$( \begin{matrix}0.9535 & 0.0412 & 0.0620 & 2.4168 \\ - 0.0717 & 1.1813 & - 0.0851 & - 14.9909 \\ 0.0456 & - 0.1423 & 1.1649 & - 16.0530\end{matrix} ) .$$

7. The liquid crystal display of claim 1, wherein the gamma converter comprises an R data modifier, a G data modifier and a B data modifier for performing the gamma conversion for the input image data for respective red, green and blue colors, the liquid crystal display further comprises a target image data storage storing a map from the input image data into output image data having a gamma characteristic adapted to the gamma 2.2 curve and a controller loading the map stored in the target image data storage into the data modifiers, and the data modifiers select the output image data corresponding to the input image data from the loaded map and outputting the selected output image data.

8. The liquid crystal display of claim 6, wherein the data modifiers comprise a volatile memory, and the target image data storage comprises a nonvolatile memory element.

9. The liquid crystal display of claim 6, wherein the target image data storage includes a nonvolatile memory in the signal controller and a nonvolatile memory element provided external to the signal controller.

10. The liquid crystal display of claim 1, wherein the gamma converter obtains the output image data from the input image data by way of a mathematical operation.

11. A method of driving a liquid crystal display, the method comprising:
converting gamma characteristic of input image data to be adapted to a gamma 2.2 curve;
performing color correction on the input image data by applying a color correction matrix for reducing color difference;
controlling luminance of a backlight to be larger than about 80 cd/m²; and
generating a plurality of gray voltages by dividing a predetermined voltage lower than a supply voltage such that a predetermined one of the gray voltages gives a luminance of about 80 cd/m².

12. The method of claim 11, wherein the gamma characteristic conversion includes a mathematical operation realized on an application specific integrated circuit (ASIC).

13. The liquid crystal display of claim 11, wherein the color correction includes matrix operation given by:
$$( \begin{matrix}{R}_{s} \\ {G}_{s} \\ {B}_{s}\end{matrix} ) = M ( \begin{matrix}{R}_{C} \\ {B}_{C} \\ {G}_{C} \\ 1\end{matrix} ) ,$$
where M is the 3×4 color correction matrix.

14. The liquid crystal display of claim 13, wherein the color correction matrix is given by:
$$( \begin{matrix}0.9535 & 0.0412 & 0.0620 & 2.4168 \\ - 0.0717 & 1.1813 & - 0.0851 & - 14.9909 \\ 0.0456 & - 0.1423 & 1.1649 & - 16.0530\end{matrix} ) .$$
